(19) United States
(12) Patent Application Publication
(10) Pub. No.: US 2008/0072134 A1
(43) Pub. Date: Mar. 20, 2008

(54) Annotating token sequences within documents

(76) Inventors: Sreeram Viswanath Balakrishnan, New Delhi (IN); Ganesh Ramakrishnan, New Delhi (IN); Sachindra Joshi, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/532,977

(22) Filed: Sep. 19, 2006

(51) Int. Cl. G06F 17/00; G06F 7/00

(52) U.S. Cl. 715/230; 707/100; 715/231

(57) ABSTRACT

Token sequences within a number of documents are annotated. First, a base inverse index for unique tokens within the documents is received. The base inverse index includes a set of the unique tokens within the documents and a set of location lists for each unique token. Second, indices are created for a set of the token sequences within the documents from the base inverse index, to annotate the token sequences.

### FIELD OF THE INVENTION

The present invention relates generally to annotating a collection of documents, and more particularly to annotating a collection of documents using a base inverse index of the documents.

### BACKGROUND OF THE INVENTION

Entity annotation entails attaching a label, such as NAME or ORGANIZATION, to a sequence of tokens within a document. Entity annotation is typically useful in improving the accuracy of keyword-based web and document searches, as well as for data mining of text repositories. However, existing approaches to entity annotation are less than desirable.

For instance, existing approaches to entity annotation operate at the document level. Using either a rule-based or a machine learning-based annotator, the sequence of tokens within a document is fed to the annotator, and the annotator outputs corresponding labels. This approach does allow powerful natural language processing techniques to be used, such as part-of-speech tagging, phrase grammar parsing, and so on. However, a disadvantage of this approach is fundamentally a speed limitation, in that the total time taken to annotate a corpus of documents scales at least linearly with the total number of tokens within the corpus. For document collections exceeding 10⁸ or 10⁹ documents, it thus can take days to annotate a large corpus of documents, even when using highly parallel server farms.

In particular, the prior art for named entity annotation is focused on annotation on a one-document-at-a-time basis. That is, tokens in a document are analyzed, either using handcrafted or machine-learned rules, and a sequence of tokens is determined as being an entity that belongs to one of several predetermined named entity annotation types. There are two broad categories of named entity recognition systems: knowledge engineering-based systems and machine learning system-based systems. The former are typically rules based, developed by experienced language engineers making use of human intuition, and require just a small amount of training data. However, a disadvantage is that development of such systems can be time-consuming, and changes may be difficult to accommodate.

By comparison, machine learning system-based systems use large amounts of annotated training data, and changes can be achieved, albeit by re-annotating all of the training data. Machine learning system-based systems are less expensive, but their results may be less than optimal due to poor precision and recall. The present invention improves the efficiency of both rule-based and machine learning-based annotators, as is now described.

### SUMMARY OF THE INVENTION

The present invention relates to annotating token sequences within a collection of documents. A method for such annotation according to one embodiment of the invention receives a base inverse index for unique tokens within the documents. The base inverse index includes a set of the unique tokens within the documents, and a set of location lists for each unique token. Indices are created for a set of the token sequences within the documents from the base inverse index, to annotate the token sequences.

An article of manufacture of an embodiment of the invention includes a tangible computer-readable medium and means in the medium. The tangible medium may be a recordable data storage medium, or another type of tangible computer-readable medium. The means is for annotating each token within a number of documents based on a base inverse index for the documents, such as by performing a method of an embodiment of the invention, as has been described.

A computerized system of an embodiment of the invention includes a computer-readable medium and an annotation mechanism. The computer-readable medium stores a number of documents having a number of tokens, and a base inverse index previously generated for the documents. The mechanism annotates the token sequences within the documents based on the base inverse index, such as by performing a method of an embodiment of the invention, as has been described, and such that annotation of the documents occurs at the same time.

Embodiments of the invention provide for advantages over the prior art. The approach to entity annotation of the invention employs an inverse index typically created for rapid keyword-based searching of a document collection. As such, entity annotation does not occur at the document level, but rather at the document collection-level, such that annotation occurs for all the documents at substantially the same time. Operations on the inverse index are defined that enable the creation of indices to arbitrarily complex annotations from indices to simpler annotations. In one embodiment, the relationship between complex and simpler annotations is specified using a modified form of CFG. In these approaches, entity annotations for an entire collection of documents can be achieved several orders of magnitude faster than the document-based approaches within the prior art.

It is noted that the concept of using the inverted index for building complex entity annotations can be interpreted generally. For example, document classification and information extraction may all be considered forms of entity annotation that traditionally have been approached at the document level. Thus, those of ordinary skill within the art can appreciate that simple extensions to the methods described below allow for such document classification and information extraction at the index level, such that entity annotation as this phrase is used herein is inclusive of such classification and extraction.

Therefore, embodiments of the invention differ from the prior art at least in the respect that instances of annotation types are effectively found within an entire corpus, or collection, of documents, by working on the corpus-level inverted index, which itself can be determined fairly efficiently. As such, entity annotation occurs much more quickly than in the prior art. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a block diagram of a system, according to an embodiment of the invention.

FIG. 2 is a flowchart of a method for annotating documents based on an inverse index of the documents, according to an embodiment of the invention.

FIG. 3 is a flowchart of a partial method that can be employed in relation to the method of FIG. 2, according to an embodiment of the invention.

FIG. 4 is a flowchart of a partial method that can be employed in relation to the method of FIG. 2, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

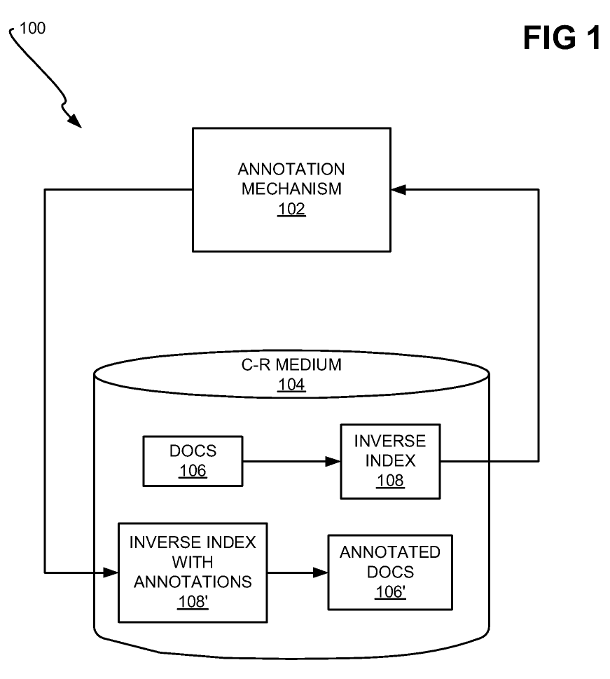

FIG. 1 shows a system 100, according to an embodiment of the invention. The system 100 includes an annotation mechanism 102 and a computer-readable medium 104. The annotation mechanism 102 may be implemented in software, hardware, or a combination of software and hardware. The computer-readable medium 104 may be a tangible computer-readable medium, and may be or include a hard disk drive, volatile semiconductor memory, as well as other types of computer-readable media. As can be appreciated by those of ordinary skill within the art, the system 100 can include other components, besides those shown in FIG. 1.

The computer-readable medium 104 stores a number of text-based documents 106. The medium 104 also stores a base inverse index 108 that is generated for the documents 106. The generation of the inverse index 108 is beyond the scope of this patent application, and can be generated in a conventional or other manner. The inverse index 108 is typically created for rapid keyword-based search of the documents 106. The inverse index 108 may be considered information regarding the occurrence of terms within the documents 106 sorted by the terms themselves.

The annotation mechanism 102 generally annotates the tokens, or terms, within the inverse index 108 to generate the annotated inverse index 108′. As such, the documents 106 are inherently annotated, as the annotate documents 106′, by virtue of the annotated inverse index 108′. Because the documents 106 are annotated by annotating the inverse index 108 of the documents 106, it can be said that the documents 106 are all annotated at the same time. That is, because the inverse index 108 pertains to all the documents 106, annotating the index 108 effectively annotates all the documents 106 at the same time. Various approaches by which the annotation mechanism 102 may annotate the inverse index 108, and thus the documents 106 from which the inverse index 108 was generated, are now described.

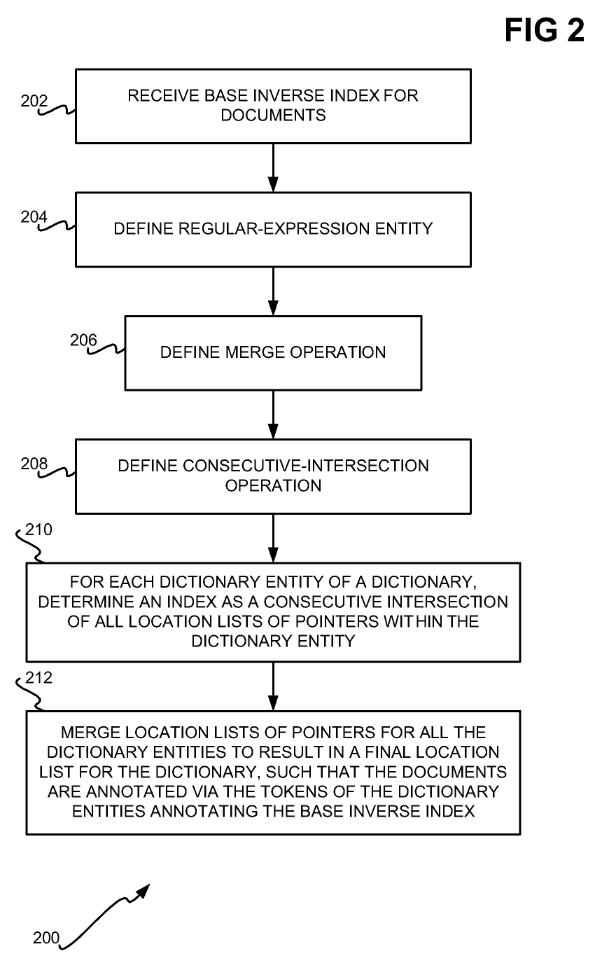

FIG. 2 shows a method 200 for annotating token sequences within a collection of documents, according to an embodiment of the invention. The method 200 is particularly performed in relation to a dictionary with a unique name and associated set of token sequences that belong to the dictionary. Thereafter, another method is described that can be performed on more general entities, referred to as derived entities, where the dictionary entities of FIG. 2 are simply a special case of such derived entities.

A base inverse index for the documents is received (202). The base inverse index is the inverse index prior to annotation thereof, and hence is described as being the base such index. It is presumed that a document collection D contains documents d(1) to d(N). The base inverse index has two ordered sets: a first ordered lists of unique tokens T with elements t(1) through t(M) that occur in the document collection D, and a set of location lists #L, where there is one list #l(i) for each unique token t(i). A location list is defined as an ordered list of pointers to the document collection D. Each pointer locates the document and the token offset of a single occurrence of the token t(i). Thus, the location list #l(i) for token t(i) can be used to locate every occurrence of t(i) within the document collection D.

It is further noted that the base inverse index is an index of base entities, where the base entities are unique tokens within the corpus of documents. Two more complex entities can be derived from the base index: regexp, or regular-expression, entities; and dictionary entities. Thus, a regular-expression entity is defined (204). A regexp entity &ERname is defined as a token that matches a regular expression % Rname. For example, if % Rcapword is ([A-Z][a-z]*), then any &ERcapword is a token corresponding to a word with an initial capital letter.

A merge operation is also defined (206). The merge operation merge(#la, #lb) returns a location list in which each pointer occurs in location list #la, location list #lb, or both location lists #la and #lb. Therefore, the location list #LRcapword for all entities &ERcapword, for example, can be composed by using merge (#la, #lb) to combine all the lists #l(i) for the tokens t(i), where t(i) satisfies % Rcapword.

A consecutive-intersection operation is also defined (208). The consecutive-operation consint(#la, #lb) is the consecutive operation of location lists #la and #lb, and returns a location list. For a pointer to be in the location list returned by consint(#la, #lb), it must point to a token sequence that consists of two consecutive subsequences @sa and @sb. Furthermore, the sequence @sa occurs in #la, and the sequence @sb occurs in #lb.

Thereafter, for each dictionary entity of a dictionary, an index is determined as a consecutive intersection of all location lists of pointers within the dictionary entity (210). A dictionary entity &EDname is defined as a sequence of tokens that occur in the dictionary $Dname. This dictionary is simply a list of token sequences, which are typically ordered. For example, if $Dfname is a list of all first names, then any token sequence annotated as &EDfname is a first name. For the simple case in which all first names are one token in length, the location list #Ldfname corresponding to all entities of type &EDfname can be composed by using merge(#la, #lb) to combine all the lists #l(i), where t(i) is in the dictionary $Dfname.

For the more complex case, in which the sequences in $Dfname are more than one token in length, the following is performed. Particularly, for each token sequence t(i1), t(i2) . . . , t(ix) in $Dfname, where x is the length of the sequence, consint(#la, #lb) is first employed to generate an index that is the consecutive intersection of the lists #l(i1), #l(i2), . . . , #l(ix). It can be appreciated by those of ordinary skill within the art that the complex case automatically collapses to the simple case where the token sequence is one token in length—that is, where x is equal to one. This index contains the pointers to all occurrences of the sequence t(il) through t(ix) in the collection. As such, the consecutive-intersection operation defined in part 208 may be considered as being used to perform part 210 of the method 200.

Thereafter, the location lists of all the token sequences that are members of the dictionary are merged to result in a final location list for the dictionary (212). As such, the documents are annotated via the tokens of the dictionary entities annotating the base inverse index. For instance, the merge operation merge (#la, #lb) is used to combine the lists for each sequence in $Dfname to yield the final location list #LDfname. As such, the merge operation defined in part 206 may be considered as being used to perform part 212 of the method 200.

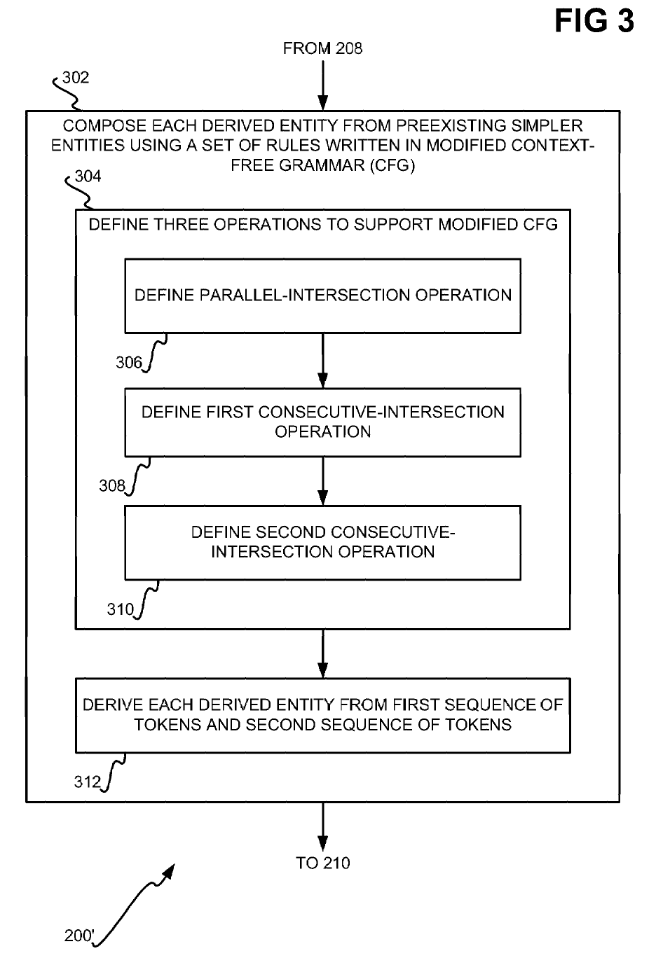

It is noted that dictionary entities as in the method 200 of FIG. 2 are a special case of more complex entities that are referred to as derived entities. FIG. 3 shows a portion of a modified method 200′ for utilizing such derived entities generally, instead of using just the dictionary entities as in the method 200 of FIG. 2, according to an embodiment of the invention. The method 200′ of FIG. 3 includes all the parts that have been described as to the method 200 of FIG. 2, but the entities employed in parts 210 and 212 of the method 200 are modified within the method 200′ as being derived entities generally, and not necessarily dictionary entities. The modified method 200′ of FIG. 3 adds to the method 200 of FIG. 2 parts 302, 304, 306, 308, 310, and 312 being performed between parts 208 and 210 of the method 200.

Each derived entity is composed from preexisting simpler entities using a set of rules written in modified context-free grammar (CFG) (302). Consider the example &EXfullname->&EDfname &EDlname. This means that the derived entity &EXfullname is composed of two consecutive sequences @seq1 and @seq2, where @seq1 is an entity of type &EDfname and @seq2 is of type &EDlname, assuming that &EDlname is the dictionary entity of last names. From the definition of consint(#la, #lb), the location list for #LXfullname for &EXfullname is obtained as follows: #LXfullname=consint(#LDfname, #LDlname). As such, &EXa→&EXb &EXc is generally interpreted as meaning that #LXa equals consint(#LXb, #LXc). Furthermore, &EXa→&EXb|EXc is generally interpreted as meaning #LXa equals merge(#LXb, #LXc).

Therefore, extending the example further, $Dnameprefix may be a dictionary of common prefixes for names such as Mr., Mrs., Ms., Dr., and so on. A derived entity &EXperson can be composed that annotates sequences as a person so long as they are a first name, full name, last name, or name prefix followed by a sequence of capitalized words of at most two in length. Thus, &EXperson→&EDfname|&EXfullname|&EDlname|&EXnewname; &EXnewname→&EDnameprefix & EXcapword2; and, &EXcapword2→&ERcapword|&ERcapword &ERcapword.

The location list for &EXperson is composed from the simpler location lists recursively, by using the operators merge(#l1, #12) and consint(#l1, #12). Hence, #LXcapword2=merge(#LRcapword, consint(#LRcapword, #LRcapword)). Further, #LXnewname=consint(#Ldnameprefix, #LXcapword2). Therefore, #LXperson merge(#LDfname, merge(#LXfullname, merge (#LXlname, #LXnewname))).

It is noted that one difficulty with the above approach is that the location list corresponding to &EXnewname can have pointers that span both the name-prefix and the sequence of the capitalized words. Therefore, it may be desirable to restrict the pointers so that they ignore the name-prefix. Another restriction that may be desired is that the capitalized words are also nouns, assuming that there is a noun entity annotator.

Therefore, the CFG is modified to include three operations (304). A parallel-intersection operation is defined (306). This operation parallelint(#la, #lb) is the parallel intersection of #la and #lb, returning the subset of pointers to sequences that are present in both #la and #lb. Thus, one modification of the CFG, using this parallel-intersection operation, is that &EXa→&EXb̂&EXc is interpreted to mean that the entity &EXa corresponds to a sequence of tokens that have both &EXb and &EXc annotations, and both of which fully span the sequence. That is, given the production rule &EXa→&EXb̂&EXc, the location list #LXa for &EXa is determined as #LXa=parallelint(#LXb, #LXc).

A first extension to consecutive-intersection operation is also defined (308), as well as a second extension to consecutive-intersection operation (310), where both of these operations are different than the consecutive-intersection operation defined in part 208 of FIG. 2. The first extension to consecutive-intersection operation is consintwp(#la, #lb), and the second extension to consecutive-intersection operation is consintws(#la, #lb). Both return an ordered list of pointers. In the case of consintwp, the returned list is a subset of #lb and has the property that each sequence in this subset is immediately preceded by a sequence from within #la. For consintws, the returned list is a subset of #la, where each sequence within the subset is immediately followed by a sequence in #lb.

Thus, another modification of the CFG, using these two consecutive-intersection operations, is that &EXa→{&EXb}&EXc is interpreted to mean that entity &EXa is formed from two consecutive token sequences @seq1 and @seq2, where @seq1 is of type entity &EXb and @seq2 is of type entity &EXc. The curly brackets denote that where the location list for &EXa is computed, the pointers skip @seq1 and just point to @seq2. Thus, the location list #LXa for &EXa→{&EXb } &EXc is determined as #LXa=consintwp(#LXb, #LXc) and the location list #LXa for &EXa→&EXb {&EXc } is determined as #LXa=consintws(#LXb, #LXc).

Using this modified CFG, then, each derived entity may be derived from a first sequence ot tokens and a second sequence of tokens (312), as an example of which has been described in relation to the initial description of part 302. Thus, an arbitrarily complex annotation may be composed from simpler annotations. For the person-name example, the final set of rules that use the above modification are: &EXperson→&EDfname|&EXfullname|&EDlname|&EXnewname; &EXnewname→{&EDnameprefix} &EXncapword2; &EXncapword2→&ERncapword|&ERncapword &Erncapword; and, &EXncapword→&EXnoun̂&ERcapword.

It is assumed that &EXnoun is the annotation for all tokens that are nouns. The corresponding location lists are determined as follows. First, #LXncapword=parallelint(#LXnoun, #LRcapword). Second, #LXncapword2=merge( #LXncapword, consint(#LXncapword, #LXncapword)). Third, #LXnewname=consintwp( #LDnamepref#LX, #LXcapword2). Finally, fourth, #LXperson=merge( #LDfname, merge( #LXfullname, merge( #LXlname, #LXnewname))).

It is noted that the method 200 of FIG. 2 that has been described, as can be modified to result in the method 200′ of FIG. 3, assumes that the entity annotations are independent of one another, and that a sequence of tokens within a document collection can have multiple overlapping annotations. However, in some situations, it may be desirable to impose a partial ordering of the annotations such that lower-order annotations do not overlap with higher-order annotations. For example, where a sequence may be either an organization name or a person name, it may be desired to give priority to one over the other.

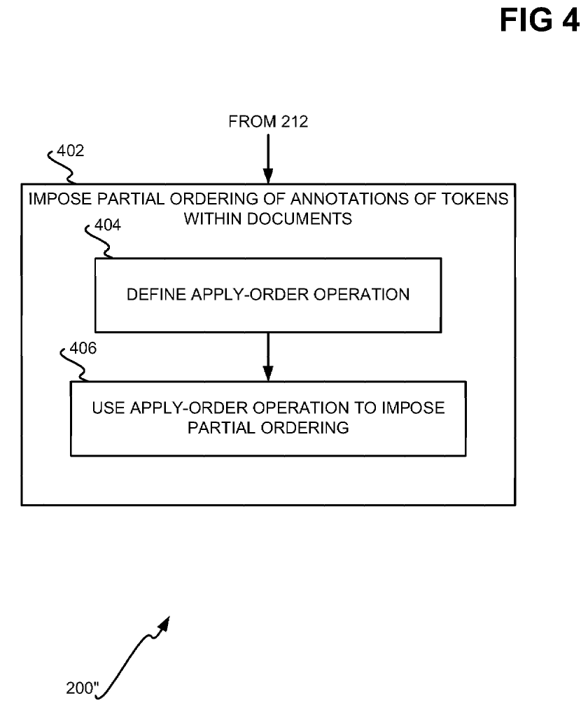

Therefore, FIG. 4 shows a portion of a modified method 200″ for imposing such ordering, according to an embodiment of the invention. The method 200″ of FIG. 4 includes all the parts that have been described as to the method 200 of FIG. 2, and which can be modified as has been described as to the method 200′ of FIG. 3. The method 200″ of FIG. 4 adds to the method 200 or the method 200′ parts 402, 404, and 406 after part 212, which are now described.

In general, as has been noted, a partial ordering of annotations of tokens within the documents is imposed (402). In particular, and in one embodiment, an array tokStatus of the integers of size equal to the total number of tokens within the document collection in question is created. This array is initialized with zeros. A positive integer is associated with each annotation type so that the order of these integers reflects the partial ordering of the annotation types that is desired to be imposed. Annotation types that are at the same level and that can overlap have the same integer associated with them.

An apply-order operation is defined (404). This operation tokStatus.applyorder(x, #lp) takes as arguments, the location list #lp of an annotation type, and the associated integer x for that type. The operation returns a subset of pointers from #lp for which all the tokens in the sequences in #lp have associated values in tokStatus less than or equal to x. In addition, the tokStatus values for the sequences that are returned are updated to the value x. Therefore, if any part of a token sequence has already been annotated as an entity with a higher value of x, this token sequence will be removed from the list of pointers in #lp.

Thus, the apply-order operation is employed to impose a desired partial ordering (406), as defined in the array tokStatus. To ensure the location lists correctly reflect the partial ordering of the entities, the apply-order operation is applied in descending order of x values. That is, the operation is performed beginning with the highest order annotation types.

It is noted that as an alternative to determining tokStatus.applyorder(x, #lp) as a post-processing operation on a location list, this operation can be combined the operation merge( #la, #lb). For instance, the operation tokStatus.merge( #la, #lb, x) can be defined as the operation that returns a location list which is a merge of the lists #la and #lb and which satisfies the constraints that tokStatus.applyorder(x, #lp) imposes on the resulting list. There may be efficiency reasons for using this alternative approach, since while the location lists are being merged the token sequences can be simultaneously checked against tokStatus.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method for annotating token sequences within a plurality of documents comprising:
receiving a base inverse index for unique tokens within the plurality of documents, where the base inverse index comprises a set of the unique tokens within the plurality of documents and a set of location lists for each unique token; and,
creating indices for a set of the token sequences within the plurality of documents from the base inverse index, to annotate the token sequences.

2. The method of claim 1, wherein the base inverse index has an ordered list of the unique tokens, and each location list of the base inverse index is an ordered list of pointers to the plurality of documents.

3. The method of claim 2, wherein each location list comprises an ordered list of pointers configured to locate a document from the plurality of documents and a token offset within the document corresponding to a single occurrence of a token sequence associated with the location list.

4. The method of claim 2, wherein an annotation is defined as a dictionary label associated with all the token sequences annotating dictionary entities of a dictionary, the method further comprising:
creating an index for each token sequence within the dictionary having more than one token, as a multiple-token entry within the dictionary; and,
creating an index to a final dictionary annotation, by merging the indices for the multiple-token entries within the dictionary and single token entries within the dictionary.

5. The method of claim 4, wherein creating an index for each token sequence within the dictionary having more than one token comprises searching indices for a sequence of tokens within the token sequence for a subset of locations in which all tokens sequentially occur in the sequence.

6. The method of claim 1, further comprising defining a regular-expression entity as a token that matches a regular expression, the regular-expression entity employed in annotating the token sequences within the plurality of documents.

7. The method of claim 1, further comprising defining a merge operation operable on a first location list and a second location list that returns a location list of pointers, where each pointer of the location list returned is within the first location list or the second location list.

8. The method of claim 1, further comprising defining a consecutive-intersection operation operable on a first location list and a second location list that returns a location list of pointers.

9. The method of claim 8, wherein each pointer of the location list returned points to a sequence of tokens having a first consecutive subsequence within the first location list and a second consecutive subsequence within the second location list, and
wherein determining the index as the consecutive intersection of all of the plurality of location lists of pointers within the dictionary entity comprises employing the consecutive-intersection operation.

10. A method for annotating each of a plurality of tokens within a plurality of documents comprising:
receiving a base inverse index for the plurality of documents, the base inverse index having an ordered list of unique tokens and a set of location lists for each unique token, each location list being an ordered list of pointers to the plurality of documents;
for each of a plurality of derived entities, each derived entity being a sequence of tokens, determining an index as a consecutive intersection of all of a plurality of location lists of pointers within the derived entity, such that the index contains location lists of pointers to all occurrences of the sequence of tokens of the derived entity within the plurality of documents; and,
merging the location lists of pointers for all the derived entities to result in a final location list, such that the documents are annotated with the tokens of the derived entities.

11. The method of claim 10, further comprising composing each derived entity from a plurality of preexisting simpler entities using a set of rules written in modified context-free grammar (CFG).

12. The method of claim 11, wherein composing each derived entity from the preexisting simpler entities using the set of rules written in modified CFG comprises deriving the derived entity from a first consecutive sequence of tokens and a second consecutive sequence of tokens.

13. The method of claim 12, further comprising modifying the CFG from each derived entity is composed from preexisting simpler entity rules, comprising:
defining a parallel intersection operation operable on a first location list and a second location list that returns a location list of pointers that is a subset of pointers to sequences of tokens within both the first location list and the second location list.

14. The method of claim 13, wherein modifying the CFG further comprises:
defining a first extension to consecutive-intersection operation operable on a first location list and a second location list that returns a location list of pointers that is a subset of the second location list, where every sequence within the subset is immediately preceded by a sequence within the first location list; and,
defining a second extension to consecutive-intersection operation operable on a first location list and a second location list that returns a location list of pointers that is a subset of the first location list, where every sequence within the subset is immediately preceded by a sequence within the second location list.

15. The method of claim 10, further comprising defining a merge operation operable on a first location list and a second location list that returns a location list of pointers, where each pointer of the location list returned is within the first location list or the second location list,
wherein merging the location lists of pointers for all the derived entities comprises employing the merge operation.

16. The method of claim 10, further comprising defining a consecutive-intersection operation operable on a first location list and a second location list that returns a location list of pointers, where each pointer of the location list returned points to a sequence of tokens having a first consecutive subsequence within the first location list and a second consecutive subsequence within the second location list,
wherein determining the index as the consecutive intersection of all of the plurality of location lists of pointers within the derived entity comprises employing the consecutive-intersection operation.

17. The method of claim 10, further comprising imposing a partial ordering of annotations of the tokens within the plurality of documents, so that lower-order annotations do not overlap with higher-order annotations.

18. The method of claim 17, further comprising defining on apply-order operation operable on a location list having an annotation type and an associated integer for the annotation type that returns a location list of pointers that is a subset of the location list having the annotation type for which all tokens in sequences of the subset returned having values less than or equal to the associated integer,
wherein imposing the partial ordering comprises employing the apply-order operation.

19. An article of manufacture comprising:
a tangible computer-readable medium; and,
means in the medium for annotating each of a plurality of tokens within a plurality of documents based on a base inverse index for the plurality of documents.

20. A computerized system comprising:
a computer-readable medium storing:
a plurality of documents having a plurality of tokens;
a base inverse index previously generated for the documents;
a mechanism to annotate each token within the documents based on the base inverse index, such that annotation of the plurality of documents occurs at a same time.
